(19) United States
(12) Patent Application Publication
(10) Pub. No.: US 2007/0018911 A1
(43) Pub. Date: Jan. 25, 2007

(54) Plasma display device

(76) Inventors: Sang-Hoon Yim, Yongin-si (KR); Yoon-Hyoung Cho, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,227

(22) Filed: Jul. 19, 2006

(30) Foreign Application Priority Data
Jul. 21, 2005 (KR) 10-2005-0066248

(51) Int. Cl. G09G 3/28

(52) U.S. Cl. 345/60

(57) ABSTRACT

A plasma display device is disclosed. The plasma display device includes two opposing substrates, address electrodes, and display electrodes. A plurality of discharge cells are provided between the two opposing substrates. The address electrodes are formed along a first direction between the substrates. The display electrodes are formed along a second direction crossing the first direction between the substrates. Three discharge cells are adjacent to each other form a single pixel. Centers of the three discharge cells are arranged in a substantially triangle pattern. A non-discharge cell is formed between a pair of the pixels which are adjacent to each other along the second direction.

### CROSS-REFERENCE TO RELATED APPLICATION

This application claims priority to Korean patent application No. 2005-0066248 filed in the Korean Intellectual Property Office on Jul. 21, 2005, and all the benefits accruing therefrom under 35 U.S.C. §119, the contents of which are herein incorporated by reference in their entirety.

### BACKGROUND OF THE INVENTION

1. Field of the Invention

The present invention relates to a plasma display device.

2. Description of the Related Technology

Generally, a plasma display panel (PDP) device excites phosphors with vacuum ultraviolet radiation generated from plasma which is obtained through a gas discharge. The PDP device displays desired images by the use of visible light such as red (R), green (G), and blue (B) colors generated by the excited phosphors.

The PDP has been spotlighted as a flat panel display for TV and for industrial purposes with several advantages. The PDP can have a very large screen size of 60 inches or bigger with a thickness of 10 cm or less. It provides excellent color representation without serious image distortion despite the change of angles since it is a self emissive display such as a cathode ray tube (CRT). The PDP device provides high productivity and low production costs due to a simplified manufacturing process.

A three-electrode surface-discharge type of PDP may be taken as an example of a general PDP. The three-electrode surface-discharge type of PDP includes a first substrate and a second substrate spaced apart from the first substrate. Sustain electrodes and scan electrodes are formed on the first substrate and address electrodes are formed on the second substrate. The address electrodes extend along a direction to be perpendicular to the sustain and scan electrodes. A discharge gas is filled between the two substrates of the PDP.

Each PDP discharge cell is selected to be turned on by an address discharge generated between the scan and address electrodes. A sustain discharge, which actually displays a required image, occurs thereafter between the sustain and scan electrodes.

### SUMMARY OF CERTAIN INVENTIVE ASPECTS

One aspect of the present invention provides a plasma display device with a structure that is capable of realizing high efficiency and enhanced display quality.

Another aspect of the invention provides a plasma display device including i) two opposing substrates, ii) address electrodes, and iii) display electrodes. A plurality of discharge cells are provided between the two opposing substrates. The address electrodes are formed along a first direction between the substrates. The display electrodes are formed along a second direction crossing the first direction between the substrates. Three discharge cells are adjacent to each other form a single pixel. Centers of the three discharge cells are arranged in a substantially triangle pattern. Non-discharge area is formed between a pair of the pixels which are adjacent to each other along the second direction.

A center of the non-discharge area and the centers of the three discharge cells may be arranged in a substantially rectangular pattern. The center of the non-discharge area and the centers of the three discharge cells may be arranged in a substantially parallelogram pattern. The non-discharge area may be formed between a pair of pixels which neighbor to each other along a diagonal direction. The distance (LH) between centers of neighboring discharge cells of the same color along the second direction and the distance (LV) between centers of the neighboring discharge cells of the same color along the first direction may satisfy the relationship of: 2LV≦3LH≦4LV.

In another embodiment, a plasma display device further includes phosphors formed in the plurality of discharge cells. Colors of the phosphors may be red, green and blue. A black layer is formed in the non-discharge area and then constitutes a black cell. Each pixel may include a plurality of subpixels. Subpixels in aggregated pixels may include first and second groups of the subpixels extending along the second direction. The first and second groups of subpixels may be alternately arranged along the first direction. The second group of the subpixels may include two discharge cells of the single pixel. The red phosphors may be formed in one of the two discharge cells and the blue phosphors may be formed in the other of the two discharge cells. The one discharge cell and the other discharge cell may be alternately arranged.

The first group of the subpixels may include one discharge cell of the single pixel. The green phosphors may be formed in the one discharge cell. The first group of the subpixels may further include the black cell. The one discharge cell and the black cell may be alternately arranged. One of the two discharge cells and the black cell may be alternately arranged along the first direction. The green phosphors may be formed in the one of the two discharge cells. The other discharge cell and the one discharge cell may be alternately arranged along the second direction.

The single address electrode may cross the discharge cells in which phosphors of the same color are formed. The display electrodes may include i) a plurality of first electrodes arranged along a boundary of the discharge cell and ii) a plurality of second electrodes extending from the plurality of first electrodes to the discharge cell. A longest distance between a pair of first electrodes arranged along opposing boundaries of the single black cell may be longer than a longest distance between a pair of first electrodes arranged along opposing boundaries of the single discharge cell. The plurality of second electrodes extend to be away from the black cell. An average reflecting brightness of the non-discharge area is lower than an average reflecting brightness of each of the three discharge cells. A cross section of the discharge cell along the first or second direction may be shaped to be hexagonal. A cross section of the discharge cell along the first or second direction may be shaped to be rectangular.

In another embodiment, the plasma display device includes i) a plurality of discharge cells and ii) a plurality of non-discharge cells. Three discharge cells adjacent to each other form a single pixel.

Another aspect of the present invention provides a plasma display device including i) a plurality of pixels, wherein a set of three discharge cells together form each pixel, and ii) a plurality of non-discharge cells alternately arranged with respect to the plurality of pixels. Three selected adjacent pixels may generally form a triangle. The enters of three same colored discharge cells among the selected pixels may form a substantially right triangle. The area of the discharge cells forming a pixel may be substantially three times as large as the area of an adjacent non-discharge cell.

Another aspect of the present invention provides a method of manufacturing a plasma display device including i) providing a plurality of pixels, wherein a set of three discharge cells together form each pixel and ii) forming a plurality of non-discharge cells so as to alternate with respect to the plurality of pixels.

### BRIEF DESCRIPTION OF THE DRAWINGS

Embodiments of the present invention will be described with reference to the attached drawings.

FIG. 1 is a partial exploded perspective view of the PDP in accordance with an exemplary embodiment.

FIG. 2 is a partial plan view of an arrangement of pixels and electrodes of the PDP in accordance with an exemplary embodiment.

FIG. 3 is a partial enlarged view of FIG. 2.

FIG. 4 is a partial plan view of an arrangement of pixels and electrodes of the PDP in accordance with an exemplary embodiment.

FIG. 5 is a partial plan view of an arrangement of pixels and electrodes of a typical PDP.

### DETAILED DESCRIPTION OF CERTAIN INVENTIVE EMBODIMENTS

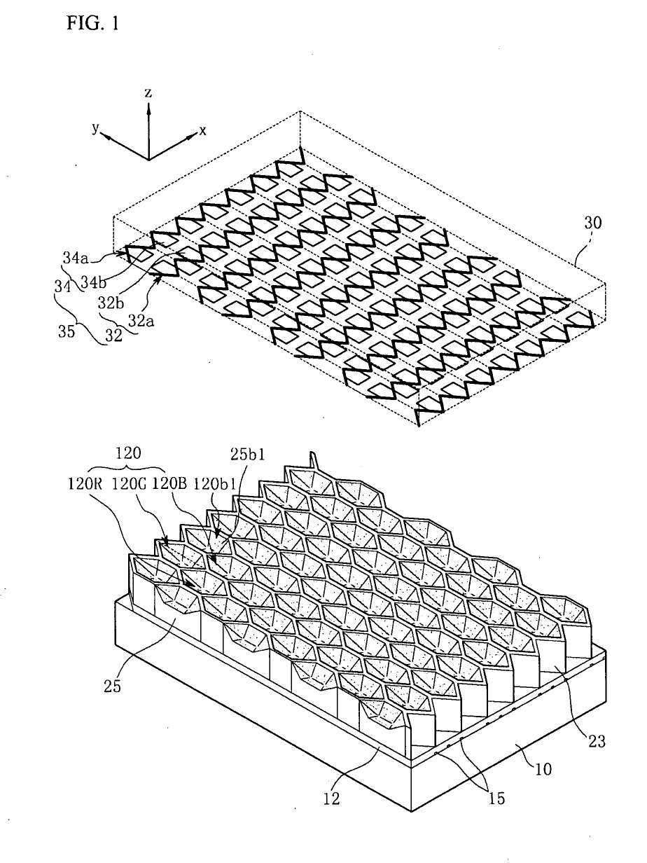

Hereinafter, embodiments of the present invention will be described with reference to FIGS. 1 to 4. These embodiments are merely to illustrate various features and aspects of the present invention, and the present invention is not limited to the illustrated embodiments. In embodiments, like reference numerals refer to like elements.

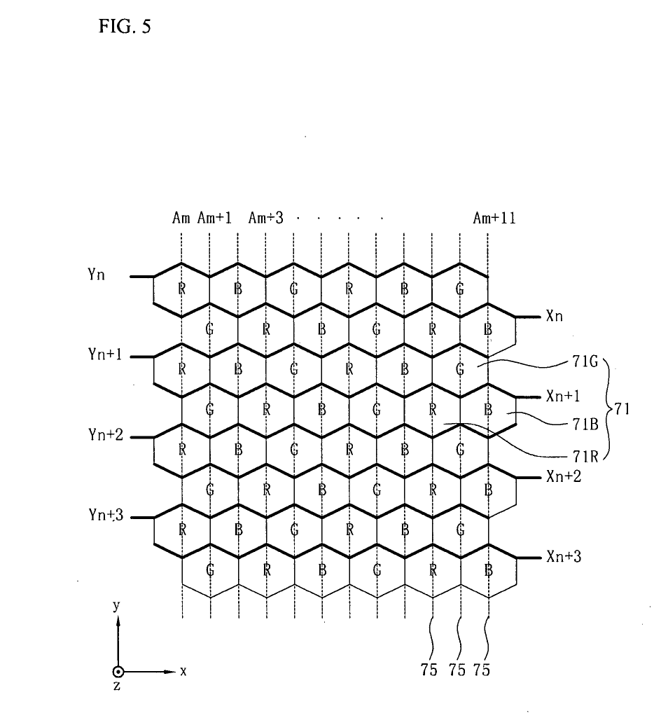

As illustrated in FIG. 5, a typical PDP has a plurality of discharge cells whose cross section (x-axis or y-axis direction) is substantially shaped as a hexagon. Reference numerals (Am to Am+11) denote a plurality of address electrodes, reference numerals (Yn to Yn+3) denote a plurality of scan electrodes and reference numerals (Xn to Xn+3) denote a plurality of sustain electrodes.

One pixel 71 is associated with three discharge cells 71R, 71G and 71B. Phosphors of red, green and blue colors are formed in the discharge cells 71R, 71G and 71B, respectively. Centers of the three discharge cells 71R, 71G and 71B form a substantially triangle. The address electrodes 15 pass each of the discharge cells 71R, 71G and 71B, respectively.

As illustrated in FIG. 5, the discharge cells 71R, 71G and 71B are arranged in a zigzag pattern. For example, the plurality of discharge cells 71R are arranged along a y-axis direction. Some discharge cells 71R are only arranged in every odd numbered rows along, for example, the address electrode Am (see the first cells of a first row, a third row and so on). Other discharge cells 71R are only arranged along every even along, for example, the address electrode Am+3 (see the second cells of a second row, a fourth row and so on). Namely, all the discharge cells 71 R are not continuously arranged along a single address electrode.

Due to the above configuration, the discharge cells of the same color are arranged in a zigzag pattern. As a result, images cannot be uniformly displayed on the PDP and thus display quality is deteriorated.

FIG. 1 shows a partial exploded perspective view of the PDP in accordance with an exemplary embodiment.

As illustrated in FIG. 1, three discharge cells 120R, 120G and 120B are arranged to form a single pixel 120. The PDP having a shape illustrated in FIG. 1 is referred to as a delta type PDP.

A non-discharge area (cell) is further formed near the pixel 120 in the PDP. Black layers 25b1 are formed in the non-discharge area and then constitute a black cell 120b1. The non-discharge area corresponds to a black cell 120b1 and there is no plasma discharge in the black cell 120b1. Therefore, an image is not displayed therein.

In an embodiment, the PDP includes a rear substrate 10 and a front substrate 30 which are spaced apart from each other by a predetermined distance. The substrates 10 and 30 are arranged to be substantially parallel to each other. A space between the rear substrate 10 and the front substrate 30 is charged with, for example, xenon (Xe) and neon (Ne) for a plasma gas discharge.

Barrier ribs 23 are disposed between the substrates 10 and 30. The discharge cells 120R, 120G and 120B are partitioned by the barrier ribs 23 having a predetermined height and shape. Here, centers of the three discharge cells 120R, 120G and 120B substantially form a triangle.

The three discharge cells 120R, 120G and 120B and a black cell 120b1 are respectively formed. In an embodiment, a cross section of the three discharge cells 120R, 120G and 120B and a black cell 120b1 along the x-axis or y-axis direction is substantially shaped as a hexagon. In this embodiment, each of the discharge cells 120R, 120G and 120B and the black cell 120b1 is shaped as a hexagonal box whose upper portion is opened. On the other hand, a shape of the black cell 120b1 can be modified in various forms. For example, a black cell 120b1 may be shaped as a hexagonal box whose upper portion is closed. In this case, a portion of the front substrate 30 which corresponds to the black cell 120b1 can be painted with black material.

Red, green and blue phosphors 25 are formed in the discharge cells 120R, 120G and 120B, respectively. Therefore, the three discharge cells 120R, 120G and 120B realize images with red, green and blue colors, respectively. The phosphors 25 and the black layers 25b1 are formed in bottom surfaces of the discharge cells 120R, 120G and 1201B, and side surfaces of the barrier ribs 23.

A plurality of address electrodes 15 are formed on the rear substrates 10 along a y-axis direction. They are arranged side by side along an x-axis direction. The plurality of address electrodes 15 are arranged to pass a space formed between the rear substrate 10 and the barrier ribs 23. The space is formed below the discharge cell 18. Furthermore, a dielectric layer 12 is formed on the entire surface of the rear substrate 10 while covering the plurality of address electrodes 15.

On the other hand, a plurality of display electrodes 35 are formed on the front substrate 30 along the x-axis direction. They are arranged side by side along the y-axis direction. The plurality of display electrodes 35 include sustain electrodes 32 and scanning electrodes 34. The sustain electrodes 32 and the scanning electrodes 34 face each other in each of the discharge cell 120R, 120G and 120B. They form a discharge gap.

The sustain electrodes 32 and the scanning electrodes 34 include bus electrodes 32a and 34a, and transparent electrodes 232b and 34b, respectively. The bus electrodes 32a and 34a are formed on the front substrate 30 along the x-axis direction. The transparent electrodes 32b and 34b extend from the bus electrodes 32a and 34a, and are not arranged in the black cell 120b1, but in the discharge cells 120R, 120G and 120B. That is, the transparent electrodes 32b and 34b are formed to be away from the black cell 120b1.

In an embodiment, the bus electrodes 32a and 34a are made of metallic materials. The bus electrodes 32a and 34a are formed in a zigzag pattern since they are arranged along a boundary of the discharge cells 120R, 120G and 120B. Widths of the bus electrodes 32a and 34a should be minimized in order for visible radiation generated in the discharge cells 120R, 120G and 120B not to be blocked when a gas discharge occurs. Meanwhile, transparent electrodes 32b and 34b made of, for example, an indium tin oxide (ITO) extend to face each other from the bus electrodes 32a and 34a. They are disposed in the discharge cell 18 in order to induce a gas discharge.

Dielectric layers (not shown) covering the display electrodes 35 are disposed on the entire surface of the front substrate 30. The protecting layer (not shown) made of, for example, MgO can be also disposed on the dielectric layer so to protect it from a gas discharge.

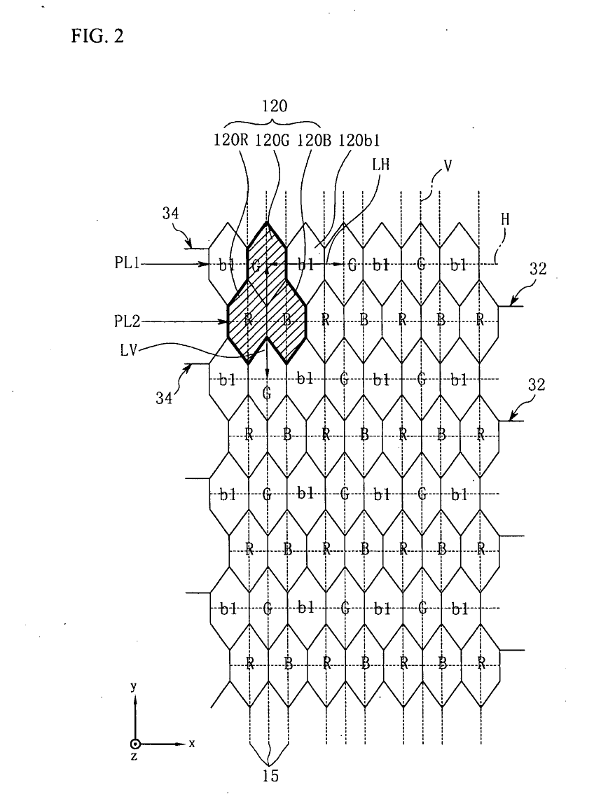

FIG. 2 shows a partial plan view of an arrangement of pixels and electrodes of the PDP in accordance with an exemplary embodiment.

As illustrated in FIG. 2, centers of the three discharge cells 120R, 120G and 120B and a black cell 120b1 are arranged in a substantially rectangular pattern. In an embodiment, they can be arranged in a substantially parallelogram pattern.

In an embodiment, the black cell 120b1 is formed between a pair of the pixels 120 which are adjacent to each other along the X-axis direction. In another embodiment, the black cells 120b1 are formed between a pair of diagonally adjacent pixels 120. (see, for example, the third cell b1 of the third row, in FIG. 2)

In an embodiment, as illustrated in FIG. 2, the address electrode 15 does not pass the black cell 120b1. In this embodiment, a gas discharge does not occur in the black cell 120b1. Heat is generated by a gas discharge occurring in the discharge cells 120R, 120G and 120B. The black cell 120b1 can absorb the heat since the gas discharge does not occur therein. The heat absorbed into the black cell 120b1 is radiated outside through the rear substrate 10 and the front substrate 30. In an embodiment, it is possible to prevent malfunction of the plasma display device due to a thermal effect. In addition, the black cell 120b1 absorbs ambient light and thus contrast ratio can be enhanced.

In an embodiment, the black layer 25b1 included in the black cell 120b1 includes materials for forming a black matrix, for example, black paints and so on. The black layer 25b1 absorbs ambient light and reduces reflection brightness. That is, light is not emitted from the black cell 1201 since the black layer 25b1 is formed therein instead of phosphors. Therefore, the reflection ratio of the black cell 1201 is lower than that of each discharge cell 120R, 120G and 120B. As a result, an average reflection brightness of the black cell 120b1 is formed to be lower than that of each of the three discharge cells 120R, 120G, and 120B. Accordingly, display quality of the image can be enhanced.

As illustrated in FIG. 2, a plurality of pixels are arranged. Each pixel includes a plurality of subpixels. The subpixels of the plurality of pixels include first and second groups of the subpixels PL1 and PL2, respectively. The first and second groups of the subpixels PL1 and PL2 extend along the x-axis direction, respectively. They are alternately arranged along the y-axis direction.

The second group of the subpixels PL2 includes the two discharge cells 120R and 120B. These subpixels are alternately arranged along the x-axis direction. The first group of the subpixels PL1 includes the discharge cell 120G and the black cell 120b1. The discharge cell 120G and the black cell 120b1 are alternately arranged along the x-axis direction.

Each address electrode 15 passes the same colored discharge cell 120R, 120G or 120B as illustrated in FIG. 2. For example, centers of the discharge cells 120G form a straight line V along the y-axis direction. In addition, centers of the discharge cells 120G form a straight line H along the x-axis direction. Therefore, centers of the discharge cells 210G are straightly arranged along the x-axis and y-axis directions. As a result, display quality of the PDP in accordance with one embodiment can be enhanced compared to that of the typical PDP shown in FIG. 5.

As illustrated in FIG. 2, LH denotes the distance between centers of neighboring discharge cells of the same color along the x-axis direction. In addition, LV denotes the distance between centers of neighboring discharge cells of the same color along the y-axis direction. The discharge cell 120G is exemplified as a discharge cell of the same color in FIG. 2. The distance (LH) and the distance (LV) satisfy the relationship of: 2LV≦3LH≦4LV. In this condition, a display image quality can be improved even if the black cells 120b1 are formed.

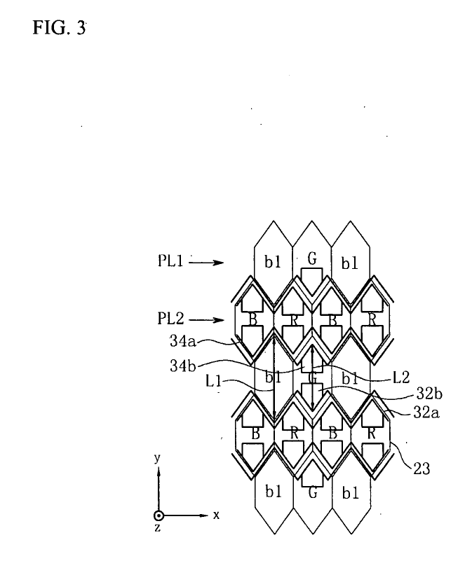

FIG. 3 shows an enlarged view of the discharge cells of FIG. 2.

As described above, the gas discharge does not occur in the black cell b1. Therefore, the bus electrodes 32a and 34a do not have to be adjacent to the black cell 120b1. In an embodiment, they are more adjacent to the discharge cells 120R, 120G and 120B. In this embodiment, the longest distance L1 between a pair of bus electrodes 32a and 34a arranged along opposing boundaries of the single black cell 120b1 is longer than the longest distance L2 between a pair of bus electrodes 32a and 34a arranged along opposing boundaries of the single discharge cell 120G. (L1>L2)

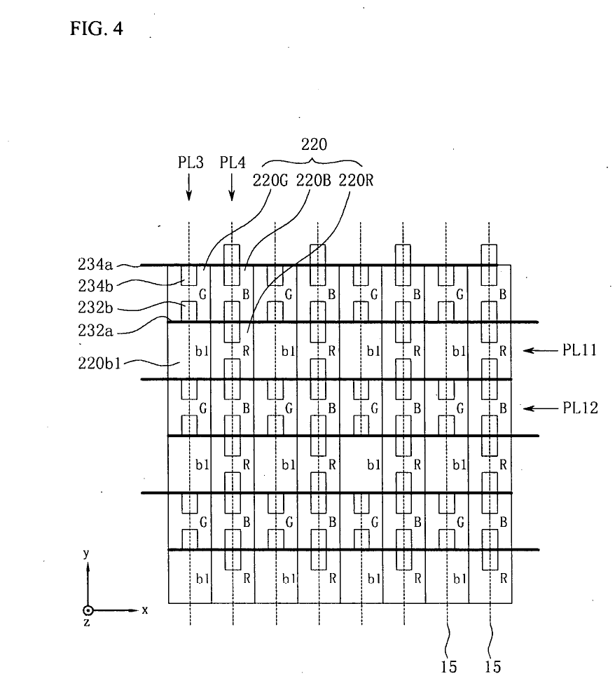

FIG. 4 shows a partial plan view of an arrangement of pixels and electrodes of the PDP in accordance with an exemplary embodiment.

As illustrated in FIG. 4, a cross section of the discharge cells 220 along an x-axis or y-axis direction is shaped to be rectangular. Therefore, discharge cells 220 and a black cell 220b1 can be straightly arranged along an x-axis or y-axis direction.

The black cells 220b1 and discharge cells 220R are alternately arranged along a row PL11. In addition, two discharge cells 220G and 220B are alternately arranged along a row PL12. In addition, discharge cells 220G and black cells 220b1 are alternately arranged along a column PL3. In addition, two discharge cells 220B and 220R are alternately arranged along a column PL4.

As noted above, centers of the three discharge cells forming a single pixel are arranged in a triangle pattern and a non-discharge area is located between neighboring pixels. The discharge cells in which green phosphors are formed can be straightly arranged in an x-axis or y-axis direction, thereby preventing images from being displayed in a zigzag pattern. In addition, the black cells are formed between adjacent pixels and thus contrast ratio can be enhanced.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display device, comprising:
two opposing substrates having a plurality of discharge cells located therebetween;
address electrodes formed along a first direction between the substrates; and
display electrodes formed along a second direction crossing the first direction between the substrates;
wherein three discharge cells adjacent to each other form a single pixel,
wherein the centers of the three discharge cells are arranged to form a substantially triangular pattern, and
wherein a non-discharge cell is formed between adjacent pixels.

2. The device of claim 1, wherein i) the center of the non-discharge cell and ii) the centers of the three discharge cells together form a substantially rectangular pattern.

3. The device of claim 2, wherein i) the center of the non-discharge cell and ii) the centers of the three discharge cells together form a substantially parallelogram pattern.

4. The device of claim 1, wherein the non-discharge cell is formed between diagonally adjacent pixels.

5. The device of claim 1, wherein the distance (LH) between centers of neighboring discharge cells of the same color along the second direction and the distance (LV) between centers of the neighboring discharge cells of the same color along the first direction satisfy the relationship of: 2LV≦3LH≦4LV.

6. The device of claim 1, further comprising phosphors formed in the plurality of discharge cells,
wherein colors of the phosphors are red, green and blue, and
wherein the non-discharge cell is coated with a black material.

7. The device of claim 6, further comprising a plurality of pixels, wherein each pixel comprises a plurality of subpixels,
wherein each subpixel is associated with a discharge cell,
wherein the plurality of pixels comprise:
a first group of subpixels arranged along the second direction; and
a second plurality of groups of subpixels arranged along the second direction; and
wherein the first group and the second plurality of groups are alternately arranged along the first direction.

8. The device of claim 7, wherein each of the second groups is associated with two discharge cells of a single pixel.

9. The device of claim 8, wherein red phosphors are formed in one of the two discharge cells and blue phosphors are formed in the other discharge cell, and
wherein the red and blue discharge cells are alternately arranged.

10. The device of claim 8, wherein each subpixel of the first group is associated with the remaining discharge cell of the single pixel.

11. The device of claim 10, wherein green phosphors are formed in the remaining discharge cell.

12. The device of claim 10, wherein the remaining discharge cell and a non-discharge cell are alternately arranged.

13. The device of claim 11, wherein a cross section of each discharge cell forms a substantially rectangular form, each subpixel of the first group is adjacent to a non-discharge cell along the second direction.

14. The device of claim 13, wherein green phosphors are formed in the one of the two discharge cells.

15. The device of claim 6, wherein a single address electrode crosses the same colored discharge cells.

16. The device of claim 6, wherein the display electrodes comprise:
a plurality of first electrodes arranged along a boundary of a discharge cell; and
a plurality of second electrodes extending from the plurality of first electrodes to the discharge cell.

17. The device of claim 16, wherein the longest distance between a pair of first electrodes arranged along opposing boundaries of a non-discharge cell is longer than the longest distance between a pair of first electrodes arranged along opposing boundaries of the discharge cell.

18. The device of claim 16, wherein the plurality of second electrodes extend to away from the non-discharge cell.

19. The device of claim 1, wherein an average reflecting brightness of the non-discharge cell is lower than an average reflecting brightness of each of the three discharge cells.

20. The device of claim 1, wherein a cross section of a discharge cell along the first or second direction is shaped to be hexagonal or rectangular.

21. A plasma display device, comprising:
a plurality of pixels, wherein a set of three discharge cells together form each pixel; and
a plurality of non-discharge cells alternately arranged with respect to the plurality of pixels.

22. The device of claim 21, wherein three selected adjacent pixels generally form a triangle, and
wherein centers of three same colored discharge cells among the selected pixels form a substantially right triangle.

23. The device of claim 21, wherein the area of the discharge cells forming a selected pixel is substantially three times as large as the area of an adjacent non-discharge cell.

24. A method of manufacturing a plasma display device, comprising:
providing a plurality of pixels, wherein a set of three discharge cells together form each pixel; and
forming a plurality of non-discharge cells so as to alternate with respect to the plurality of pixels.
